(19) United States
(12) Patent Application Publication
(10) Pub. No.: US 2004/0151059 A1
(43) Pub. Date: Aug. 5, 2004

(54) Deagglomerator apparatus and method

(76) Inventors: William Leroy Roberts II, Durham, NC (US); Michiel Mary Van Oort, Durham, NC (US)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/476,462

(22) PCT Filed: May 1, 2002
(86) PCT No.: PCT/US02/13565

(51) Int. Cl. B01F 11/00

(52) U.S. Cl. 366/112

(57) ABSTRACT

A deagglomerator apparatus and method are provided for deagglomerating material such as micron-sized, dry medicament powder (M). The deagglomerator apparatus includes a horn member (HM) having a tip portion (TP, TP1) wherein the tip portion defines a recess (R1) for holding the material. A vibrator mechanism is attached to the horn member and is operable for utilizing power from a generator (G) for vibrating the horn member, tip portion and recess wherein the recess vibrates at a frequency suitable for deagglomeration of agglomerated material held by within the recess. In a preferred embodiment, the material is held by a substrate which can be positioned at least partially into the recess. The deagglomerator apparatus and method can be used for deagglomerating material such that it includes particles of a respirable size, preferably less than approximately ten (10) microns (when referenced to unit density of 1 gram/cm₃).

### TECHNICAL FIELD

The present invention relates generally to deagglomerating apparatuses and methods, and more particularly, to a deagglomerator apparatus and method for deagglomerating micron-sized material such as medicament powder suitable for inhalation and deposition into a person's lungs.

### BACKGROUND OF THE INVENTION

It is common for respiratory diseases such as asthma to be treated by inhalation of medicament directly into a person's lungs. As such, it has been widely known in pharmaceutical and medical environments for such treatment to include either inhalation of medicament from a drug solution or suspension in an aerosol propellant from a metered dose inhaler, or to include inhalation of powdered drug generally admixed with a powdered excipient from a dry powder inhaler.

One method of providing medicament, which can be used in treatment by inhalation or other techniques, comprises utilization of a substrate which holds micron-sized medicament, wherein the medicament can be separated from the substrate and subsequently used in treatment by inhalation.

For the purposes of the present disclosure, the term “micron-sized” generally defines particles for which a fraction of the sample particle population has aerodynamic diameters ranging from approximately 0.0001 micrometers to approximately 10 micrometers, when referenced to unit density material of 1 gram/cubic centimeter. Some type of process may be used to produce particles of micron-sized diameter, in which case such particles may be characterized as being “micronized”. Additionally, for the purposes of the present disclosure, in general, all particles sizes referred to are aerodynamic and referenced to unit density material of 1 gram/cubic centimeter.

One substrate commonly used for providing medicament is a blister into which a quantity of micron-sized medicament can be placed. It is common for micron-sized medicament to be dispensed onto or into such a blister as a dry powder mixture of the medicament and a GRAS (“generally regarded as safe”) excipient such as lactose or glucose. Alternatively, medicament can be dispensed onto or into such a blister as a suspension and the suspending agent removed thereafter, such as by evaporation, leaving what can be referred to as a dried, drug or medicament “cake” on the blister. For purposes of using medicament provided by a blister for treatment, whether or not the medicament is dispensed onto the blister as a suspension, one method of removing the medicament from the substrate for subsequent inhalation or other use comprises directing a suitable air flow across and/or partially into the blister for removal of the medicament by the air stream, which may be a forced air stream.

In the past, and as can readily be appreciated by those of skill in the art, the use of medicament for inhalation as provided from a substrate, such as a blister as described above, has suffered from disadvantageous agglomeration of the medicament held by the substrate and/or the excipient when included in the formulation, especially in the case of micron-sized medicament. Agglomeration of medicament held by a substrate particularly exists when the substrate is formed by a suspension of micron-sized medicament dispensed onto the substrate. This is because as the suspending agent is removed or evaporates, the primary particles are inclined, due to surface tension, attractive forces, Brownian motion, and the suspending agent removal process to come into contact with each other, or flocculate, thereby forming a closely packed quantity of agglomerated medicament on the substrate. As a result, at least some of the medicament removed from the substrate is unsuitable for inhalation into the respiratory tract, as the particle size distribution of what can be a majority of the medicament contains agglomerates that are greater than approximately ten (10) microns in aerodynamic size (when referenced to unit density material of 1 gram/cm³), and therefore too large for suitable inhalation into the respiratory tract. It is well recognized that particles or agglomerates, in order to be of a respirable size suitable for inhalation and deposition into a person's lungs, preferably are less than approximately ten (10) microns aerodynamically, more preferably less than approximately six (6) microns, and most preferably less than approximately five (5) microns, so that the particles can be inhaled into and deposited at receptor sites within a person's lungs. An additional problem presented by such disadvantageous agglomeration of the medicament is that it is practically impossible to remove all or sometimes even most of the medicament from the substrate, as some of the medicament typically is agglomerated such that it stays adhered to the surface of the substrate itself. This problem is particularly observed in the case of micron-sized medicament.

As well known to those of skill in the art, numerous methods exist within the prior art for applying energy into medicament for purposes of deagglomerating the medicament for subsequent inhalation. Many of these methods provide an air stream to affect the desired deagglomeration energy. PCT Publication No. WO 92/00115 is an example of utilization of an air stream to provide deagglomeration energy, although the applicator blade disclosed actually causes the substrate fibers to move or vibrate as medicament is applied. PCT Publication No. WO 94/20164 provides an example of deagglomeration of a compacted, powdered medicament by the action of air impinging on the medicament and the medicament substrate in order to detach the medicament from the substrate while simultaneously deagglomerating the medicament. Additionally, many of the methods pass the medicament against or by one or more baffles or grids in order to break up or deagglomerate the medicament just prior to inhalation.

A number of other technologies exist within the prior art for deagglomeration or removal of particles from surfaces. U.S. Pat. No. 5,694,920 to Abrams illustrates use of a piezoelectric vibrator used for vibrating powder in such a way as to deaggregate the powder and separate the powder by size for purposes of subsequently suspending the powder particles in an air stream by electrostatic means. Japanese Patent reference JP 01014142, owned by Mitsubishi Mining and Cement Company, describes a method comprising dispersing agglomerated ceramic powder in a dispersion medium containing dispersant, preferably a surfactant or polymer dispersant to give a suspension, applying ultrasonic wave vibration on the suspension to deagglomerate the ceramic powder, and then evaporating off the dispersing medium to coat the deagglomerated ceramic powder with the dispersant. The method is described as preventing effectively re-agglomeration of the ceramic powder until the next firing and making possible sintering to high density even under low firing temperature.

A publication in the OSS PHARM AG, dated Aug. 14, 1996, describes preparation of pharmaceutical capsules and tablets in which ultrasonic vibration is applied to the granule or powder feed hopper. According to the description, pharmaceutical capsules, tablets, sachets, etc. are prepared in a process in which ultrasonic vibrations are applied to the granule or powder feed in the apparatus in which the capsules, tablets, sachets, etc. are made. The application of the ultrasonic vibration is described as advantageously providing better flow properties, absence of agglomerants, smoother-flow through sieves, and more even measurement due to the absence of occluded air. The ultrasonic vibrations preferred are at frequencies of 15-50 kHz, although the frequency range is described especially as 2540 kHz wherein the vibrations are preferably applied directly to the feed hopper.

Despite the existence of prior art methods and apparatuses such as those described above, there remains much room for improvement in the art, particularly for a deagglomerator apparatus and method for deagglomerating micron-sized material such as that held by a substrate.

### DISCLOSURE OF THE INVENTION

In accordance with the present invention, a deagglomerator apparatus and method are provided for deagglomerating material such as, for example, micron-sized or micronized dry medicament powder. The deagglomerator apparatus and method include a horn member having a tip portion wherein the tip portion defines a fixture or recess for holding material. A vibrator mechanism is attached to the horn member and is operable for utilizing power from a generator for vibrating the horn member, tip portion and recess. The recess vibrates at a frequency and amplitude suitable for deagglomeration of agglomerated material held within the recess. In a preferred embodiment, the material is held by a substrate which can be positioned at least partially into the recess.

It is therefore an object of the present invention to provide a novel deagglomerator apparatus and method for deagglomerating particulate material, particularly micron-sized powder medicament, suitable for inhalation and deposition into a person's lungs.

It is another object of the present invention to provide such a deagglomerator apparatus and method for deagglomerating micron-sized material held by a substrate such as a blister.

It is yet another object of the present invention to provide such a deagglomerator apparatus and method for deagglomerating micron-sized material which facilitates efficiency in using micron-sized material held by a substrate.

Some of the objects of the invention having been stated hereinabove, other objects will become evident as the description proceeds, when taken in connection with the accompanying drawings as best described hereinbelow.

### BRIEF DESCRIPTION OF THE DRAWINGS

FIG. 1 of the drawings is a side elevation view in partial cutaway of an embodiment of the deagglomerator apparatus according to the present invention;

FIG. 2 of the drawings is a perspective view of the embodiment of the deagglomerator apparatus according to the present invention shown in FIG. 1;

FIGS. 3A and 3B of the drawings are top plan views of alternative tip portions according to the present invention with differently shaped recesses;

FIGS. 4A and 4B of the drawings are top plan views of alternative substrates according to the present invention with differently shaped blisters;

FIG. 5 of the drawings is a vertical cross-sectional view of the top portion of the tip portion according to the present invention illustrating a substrate in the form of a blister fitted into the recess of the tip portion with deagglomerated micron-sized material in the blister;

FIG. 6 of the drawings is a side elevation view in partial cutaway of an alternative embodiment of the deagglomerator apparatus according to the present invention;

FIG. 7 of the drawings is a perspective view of the alternative embodiment of the deagglomerator apparatus according to the present invention shown in FIG. 6;

FIGS. 8A and 8B of the drawings are top plan views of alternative resilient fixture or pad tip portions with differently shaped recesses and adapted for use with the embodiment illustrated in FIGS. 6 and 7;

FIGS. 9A and 9B of the drawings are top plan views of alternative substrates with differently shaped blisters, which substrates can be used in conjunction with the tip portions illustrated in FIGS. 8A and 8B, respectively;

FIG. 10 of the drawings is a vertical cross-sectional view of the top portion of the alternative resilient fixture of pad attached to the tip portion according to the present invention, illustrating a substrate in the form of a blister fitted into the recess of the resilient fixture with deagglomerated micron-sized material in the blister;

FIG. 11 of the drawings is a side elevation view in partial cutaway of an embodiment of the deagglomerator apparatus wherein certain working surfaces have been reversed according to the present invention;

FIG. 12 of the drawings is a side elevation view in partial cutaway of yet another alternative embodiment of the deagglomerator apparatus according to the present invention;

FIGS. 13A and 13B are top plan and side elevation views, respectively, of a multi-blister substrate utilized in accordance with the present invention; and

FIG. 14 of the drawings is a graph that plots data collected using the deagglomerator apparatus and method for deagglomerating micron-sized material.

### DETAILED DESCRIPTION OF THE INVENTION

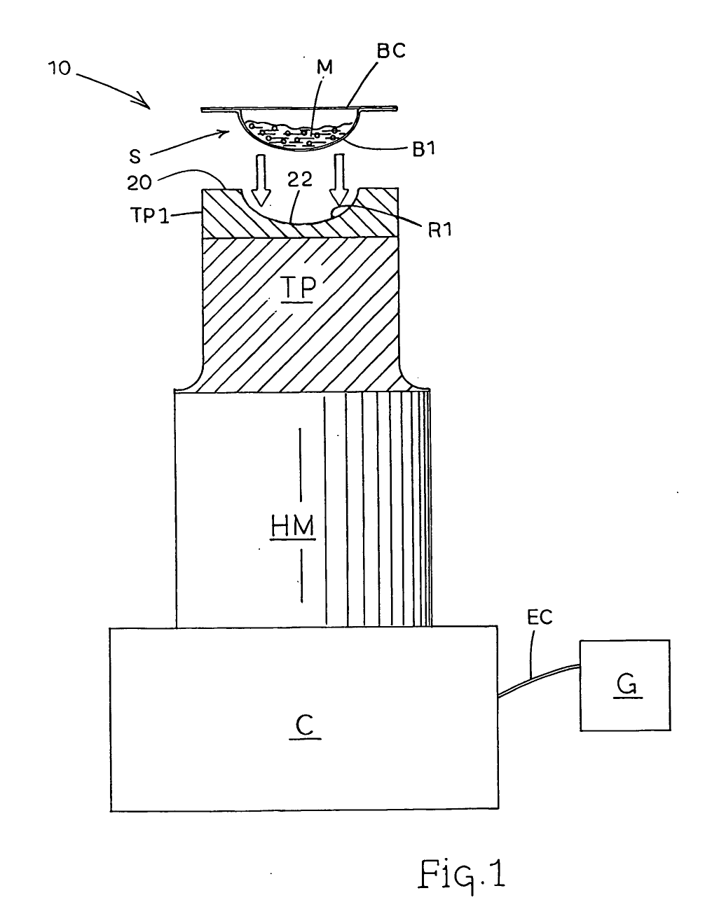

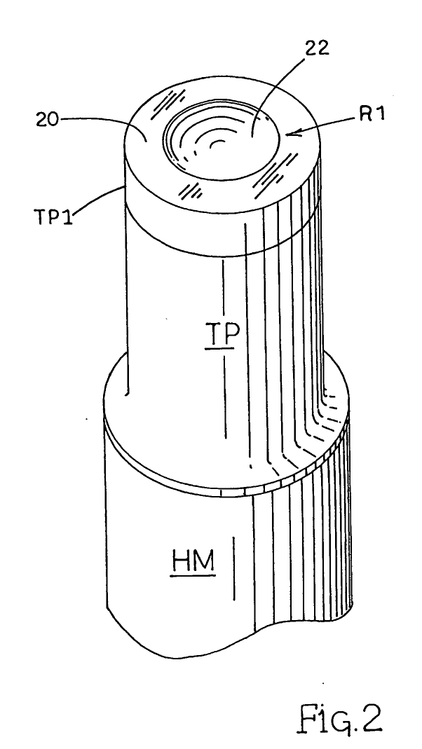

In accordance with the present invention, a deagglomerator apparatus, generally designated 10, for deagglomerating material suitable for inhalation and deposition in a person's lungs is illustrated in one embodiment in FIGS. 1 and 2 of the drawings. Deagglomerator apparatus 10 can be used for suitably deagglomerating powdered material such that it comprises particles or agglomerates of a respirable size, which is preferably aerodynamically less than approximately ten (10) microns, more preferably less than approximately six (6) microns, and most preferably less than approximately five (5) microns (aerodynamically referenced to unit density material of 1 gram/cm³), so that the particles can be inhaled into and deposited into a person's lungs to effectuate local or systemic delivery.

Deagglomerator apparatus 10 as shown in a preferred embodiment in FIGS. 1 and 2 of the drawings comprises a converter C which can be powered by a generator G. Generator G is in electrical communication with converter C by electrical connector EC to provide electrical power from generator G to converter C. If desired, a “BNC” type connector can be used at the base of connection of electrical connector EC to converter C. Generator G can be any suitable generator for purposes of deagglomerating micron-sized material in accordance with the present invention. While any generator providing suitable vibrations can be used, it has been found that a generator for converting 60 Hz 120 volt line power to 20 kHz high-voltage (e.g., 1300 volts) electrical energy is suitable for the present invention. High frequency energy from generator G is fed through electrical connector EC into converter C. Converter C preferably contains a lead zirconate titanate piezoelectric crystal which, when subjected to an alternating voltage, contracts and expands in order for converter C to vibrate. Converter C preferably vibrates in a longitudinal direction, and converter C is preferably designed to vibrate at a frequency suitable for deagglomeration of micron-sized material, such as micronized solid material, in accordance with the present invention as described further below.

It is envisioned that converter C can comprise any suitable mechanism for providing vibration in accordance with the desired purpose of the present invention. As such, converter C can be an ultrasonic converter, also known as a sonicator, such as Model No. CL4 that is commercially available from Misonix, Inc. of Farmingdale, N.Y. While a frequency in the range of approximately 20 kHz is considered suitable for the frequency of vibration for which converter C is adapted to vibrate, converter C can be designed for vibration at various frequencies suitable for deagglomeration of micron-sized solid material in accordance with the present invention. For example, it is envisioned that converter C can be designed for providing vibration at frequencies considered ultrasonic or sonic, wherein the dividing line between ultrasonic and sonic is typically considered to be approximately 19 kHz.

Attached to converter C is a horn member HM, which can be attached to converter C in any suitable fashion such as attached removably or attached integrally. Horn member HM typically is readily commercially available as attached to commercially available converters, and is integrally attached to converter C identified above which is particularly suitable for use with the present invention. A tip portion TP is attached to horn member HM, on an opposite side of horn member HM from the side of attachment of horn member HM to converter C. Tip portion TP can be attached to horn member HM in any suitable fashion, although more typically it is envisioned that tip portion TP will be attached to horn member HM so as to easily be removable therefrom.

Tip portion TP defines a recess, shown as recess R1 in FIGS. 1, 2, 3A, and 5, in what is preferably a flat, top surface 20 of tip portion TP, with flat, top surface 20 being on an opposite side of tip portion TP from horn member HM, as best illustrated in FIGS. 1, 2, 3A and 5 of the drawings. As further discussed below, recess R1 is adapted for receiving micron-sized material and can be of a variety of shapes and sizes.

The attachments of horn member HM to converter C and tip portion TP to horn member HM are such that vibration provided by converter C can pass through horn member HM, and be conducted by horn member HM to tip portion TP where the vibration can then pass all the way to flat, top surface 20 of tip portion TP so as to likewise cause vibration of recess R1. Although it is envisioned according to the present invention that the materials of construction of horn member HM and tip portion TP can be of any material suitable for conducting, passing and causing vibration in accordance with this invention for a deagglomeration of micron-sized material, horn member HM and tip portion TP preferably are constructed of a metallic material, such as, for example, stainless steel, aluminum or titanium. As an alternative, tip portion TP could also include an uppermost distal portion TP1 constructed from a different material such as sapphire, such that tip portion TP can include a combination of metallic and ceramic materials. Distal portion TP1 could be secured to tip portion TP such as by screwing distal portion TP1 into a tapped bore (not shown) of tip portion TP.

As an example of vibration transfer in deagglomerator apparatus 10 according to the present invention, generator G can provide electrical power to converter C to cause converter C to vibrate at a frequency of between approximately 60 Hz and approximately 1000 kHz, or more preferably between approximately 10 kHz to approximately 120 kHz, and even more preferably ultrasonically at approximately 20 kHz. Such vibrational energy provided by converter C is transferred from converter C to and through horn member HM and then to and through tip portion TP such that tip portion TP, including the recess, vibrates with an amplitude of between approximately 1000 to approximately 0 micrometers, or more preferably between approximately 120 to approximately 0 micrometers, or even more preferably between approximately 60 to approximately 0 micrometers—the exact amplitude being matched to the requirements of the particular details of the application of the present invention. If desired, a weight block or backing W1 shown in FIG. 5 may be employed in the invention depending on the particular application in order to help ensure good mechanical contact between a blister such as blister B1 and tip portion TP.

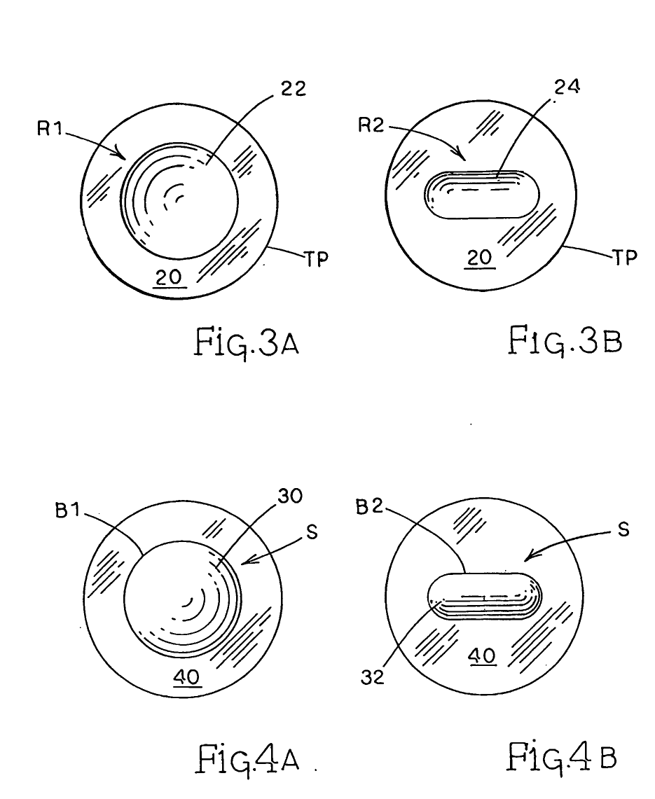

As mentioned above, recess R1 defined within flat, top surface 20 of tip portion TP is adapted for receiving micron-sized material in accordance with this invention. The shape, configuration and size of recess R1 can be any suitable for deagglomeration of micron-sized material as taught by this invention. FIGS. 1, 2, 3A and 5 illustrate recess R1 which is circular shaped as seen on flat, top surface 20 of tip portion TP, and recess R1 with its inner surface 22 is at least generally in the shape of a half of a sphere. FIG. 3B of the drawings illustrates another embodiment as recess R2, which is oval-shaped as seen on flat, top surface 20 of tip portion TP, and recess R2 with its inner surface 24 is at least generally in the shape of one half of an elongated tube or ovoid.

While the actual dimensions for the recess according to any embodiment of this invention can vary so long that they are suitable for the recess to receive micron-sized material, it has been found according to this invention that suitable dimensions for the oval-shaped and/or spherical-shaped recesses are 0.5 inch in length, 0.35 inch in width, and 0.157 inch in depth, or more preferably are 0.25 inch in length, 0.225 inch in width, and 0.0785 inch in depth and even more preferably 0.236 inch in length, 0.153 inch in width, and 0.061 inch in depth.

While it is envisioned that the recess in tip portion TP, such as recesses R1 and R2, can directly receive micron-sized material, the recess more typically utilized in accordance with this invention receives material held by a substrate, generally designated S, and which is illustrated in one embodiment in FIGS. 1, 4A and 5 of the drawings as blister B1. Blister B1 holds material M, which in accordance with this invention preferably comprises powder medicament as can be appreciated by those of skill in the art and as described below, although it is envisioned that material M can comprise other types of material.

Substrate S can comprise any suitable substrate for holding micron-sized material, and although FIGS. 1, 4A and 5 of the drawings illustrate substrate S in one embodiment as blister B1, it is also envisioned that other types of substrates can be used in association with the present invention for holding micron-sized material. For example, substrate S can comprise a screen defining a plurality of interstices wherein the screen is adapted for holding micron-sized material. In addition, substrate S such as blister B1 could include an intermediate element such as a ball or a screen, which can also be vibrated to enhance the deagglomeration effect.

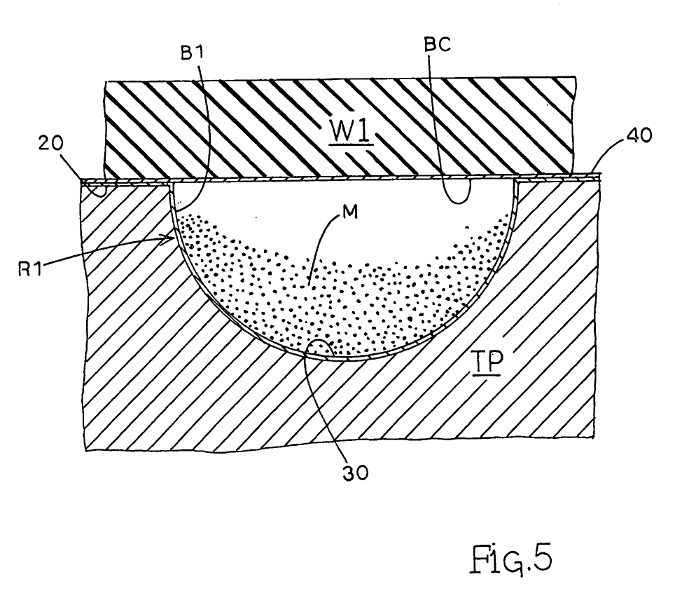

When substrate S is in the form of a blister, such as blister B1 shown in FIGS. 1, 4A and 5, the blister can be of various sizes and configurations. For example, blister B1 shown in FIGS. 1, 4A and 5 of the drawings with its inner surface 30 is at least generally in the shape of a half of a circular sphere, and blister B1 is circular shaped as seen on flat, top surface 40. FIG. 4B of the drawings illustrates another embodiment of the blister of deagglomerator apparatus 10 according to this invention, as blister B2. Blister B2 is oval-shaped as seen on flat, top surface 40, and blister B2 with its inner surface 32 is at least generally in the shape of one half of an elongated tube. It is certainly envisioned according to the present invention that the blister of deagglomerator apparatus 10 could be of a shape and size other than as illustrated in FIGS. 4A and 4B.

As for material of construction, the blister, such as blisters B1 and B2, in accordance with this invention can be of any materials suitable for holding micron-sized material, such as aluminum, or plastics of appropriate thickness, or laminates of appropriate materials such as aluminum foil and plastic. While the actual dimensions for a blister according to this invention can vary so long that they are suitable for the blister to hold micron-sized material and function for deagglomeration of micron-sized material according to this invention, it has been found that suitable dimensions for the oval-shaped and/or spherical-shaped blisters are approximately 0.5 inch in length, 0.35 inch in width, and 0.157 inch in depth, or more preferably 0.25 inch in length, 0.225 inch in width, and 0.0785 inch in depth, and even more preferably 0.236 inch in length, 0.153 inch in width, and 0.061 inch in depth, in order for the blister to be able to hold approximately 5000 micrograms or less of micron-sized solid material therein. As a general matter, the blisters should be at least slightly smaller than the recesses in order for the blisters to fit into the recesses.

In accordance with this invention, and using blister B1 of FIGS. 1, 4A and 5 for illustrative purposes and without limitation, material M is held within blister B1 against bottom surface 30 of blister B1. Material M can comprise any suitable type of material, especially micron-sized material, which can be produced by a variety of methods. Non-limiting examples of suitable material M include low-density particles; drug/excipient co-precipitates; porous, fissured or hollow particles including medicament, and optionally coated with materials such as surfactants, excipients, penetration enhancers, targeting materials, and/or charged particles; admixtures; spray-dried medicaments; friable tablets of medicaments; and friable tablets of medicament/excipient mixtures. Material M in accordance with the present invention preferably is micron-sized, solid material resulting from a suspension of micron-sized material previously dispensed into or on blister B1, wherein the suspending agent utilized has been removed, such as by evaporation. As will readily be appreciated by those of skill in the art, a suspension typically comprises a two-phase system consisting of a solid material, such as a drug or medicament, in a suspending media such as a liquid media.

More specific, non-limiting examples of suitable material M may be selected from the following medicaments: analgesics, e.g., codeine, dihydromorphine, ergotamine, fentanyl or morphine; anginal preparations, e.g., diltiazem; antiallergics, e.g., cromoglycate (e.g. as the sodium salt), ketotifen or nedocromil (e.g. as the sodium salt); anti-infectives, e.g., cephalosporins, penicillins, streptomycin, sulphonamides, tetracyclines and pentamidine; antihistamines, e.g., methapyrilene; anti-inflammatories, e.g., beclomethasone (e.g. as the dipropionate ester), fluticasone (e.g. as the propionate ester), flunisolide, budesonide, rofleponide, mometasone (e.g. as the furoate ester), ciclesonide, triamcinolone (e.g. as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pirbuterol (e.g. as acetate), reproterol (e.g. as hydrochloride), rimiterol, terbutaline (e.g. as sulphate), isoetharine, tulobuterol or 4-hydroxy-7-[2-[[2-[[3-(2-phenylethoxy)propyl]sulfonyl]ethyl]amino]ethyl-2(3H benzothiazolone; [adenosine 2a agonists, e.g. (2R,3R,4S,5R)-2-[6-Amino-2-(1S-hydroxymethyl-2-phenyl-ethylainino)-purin-9-yl]-5-(2-ethyl-2H-tetrazol-5-yl)-tetrahydro-furan-3,4-diol (e.g. as maleate)]; [α₄ integrin inhibitors e.g. (2S)-3-[4-({[4-(aminocarbonyl)1-piperidinyl]carbonyl}oxy)phenyl]-2-[((2S)4-methyl-2-{[2-(2-methylphenoxy) acetyl]amino}pentanoyl)amino]propanoic acid (e.g. as free acid or potassium salt)], diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin, parathyroid hormone or glucagon; vaccines, diagnostics, and gene therapies.

It will be clear to a person skilled in the art that, where appropriate, the medicaments may be used in the form of salts (e.g., as alkali metal or amine salts or as acid addition salts) or as esters (e.g., lower alkyl esters) or as solvates (e.g., hydrates) to optimize the activity and/or stability of the medicament and/or to minimize the solubility of the medicament in the suspending media.

Preferred medicaments are selected from albuterol, salmeterol, fluticasone propionate and beclomethasone dipropionate and salts or solvates thereof, e.g., the sulphate of albuterol and the xinafoate of salmeterol.

Medicaments can also be delivered in combinations. Preferred formulations containing combinations of active ingredients contain salbutamol (e.g., as the free base or the sulphate salt) or salmeterol (e.g., as the xinafoate salt) or formoterol (e.g., as the fumarate salt) in combination with an anti-inflammatory steroid such as a beclomethasone ester (e.g., the dipropionate) or a fluticasone ester (e.g., the propionate) or budesonide. A particularly preferred combination is a combination of fluticasone propionate and salmeterol, or a salt thereof (particularly the xinafoate salt). A further combination of particular interest is budesonide and formoterol (e.g. as the fumarate salt).

Subsequent to removal of the suspending media, such as the liquid of a liquid media, the remaining material, which can be referred to as a material or drug “cake”, typically adheres to the inner surfaces of the blister, such as inner surface 30 of blister B1 in FIG. 5. Because of surface tension, attractive forces, Brownian motion, and the suspending agent removal process, the particles constituting the material resulting from the suspension are inclined to come into contact with one another so as to flocculate and form a closely packed, dry quantity of agglomerated material, as described in the background section above.

As mentioned above, and continuing to use blister B1 for illustrative purposes, substrate S, illustrated as blister B1 in FIGS. 1, 4A and 5, preferably has a configuration or contour such that blister B1 is receivable within and can be placed into recess R1, as shown in FIG. 5 of the drawings. It can similarly be understood that blister B2 shown in FIG. 4B would fit into recess R2 of FIG. 3B. Whatever configuration is utilized for the substrate, such as blister B1 in FIGS. 1, 4A and 5, the recess, such as recess R1, most preferably has an identical or at least substantially similar shape such that the recess can receive the substrate. As can be appreciated by those of skill in the art, it is greatly desirable for the shape, configuration and size of the substrate, such as blister B1 in FIGS. 1, 4A and 5, and the shape, configuration and size of recess R1 to match so that the bottom surface area of the substrate and the inner surface of the recess flushly and tightly contact one another as much as possible for effective vibration and thus deagglomeration of micron-sized solid material in accordance with this invention. Backing W1 in FIG. 5 may be utilized to assist in the deagglomeration process by applying a controlled pressure as appropriate according to this invention.

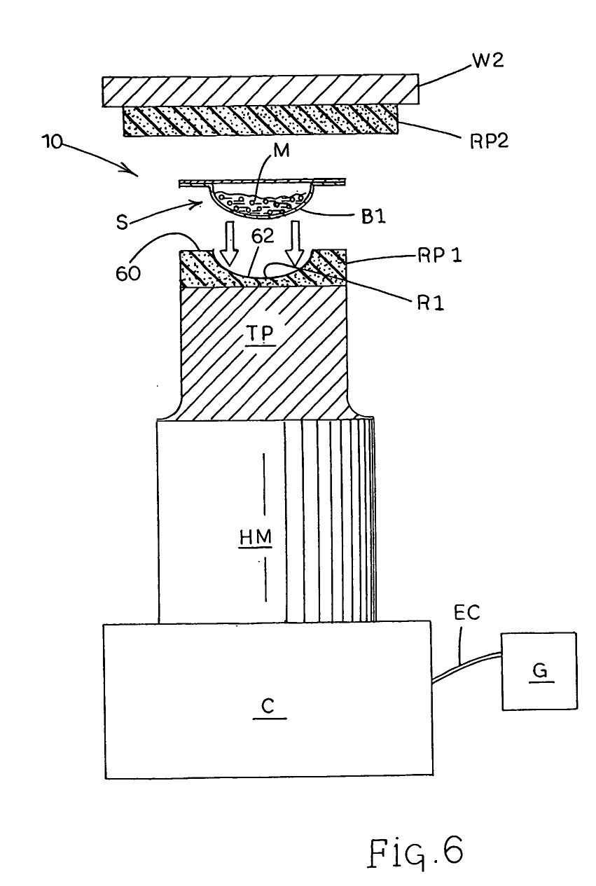

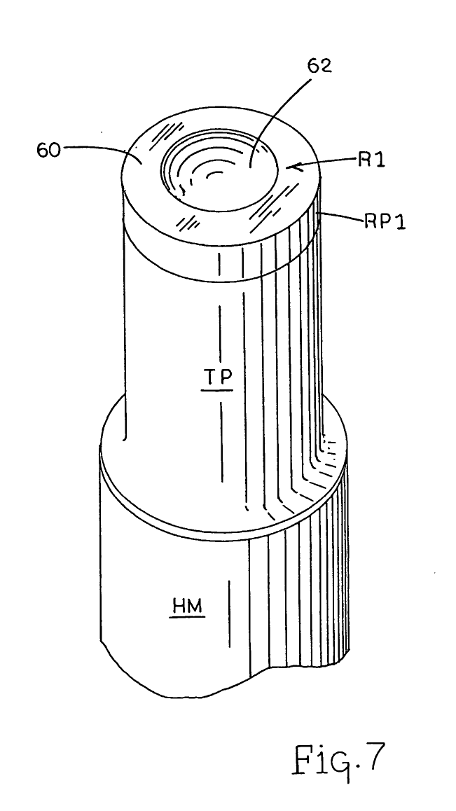

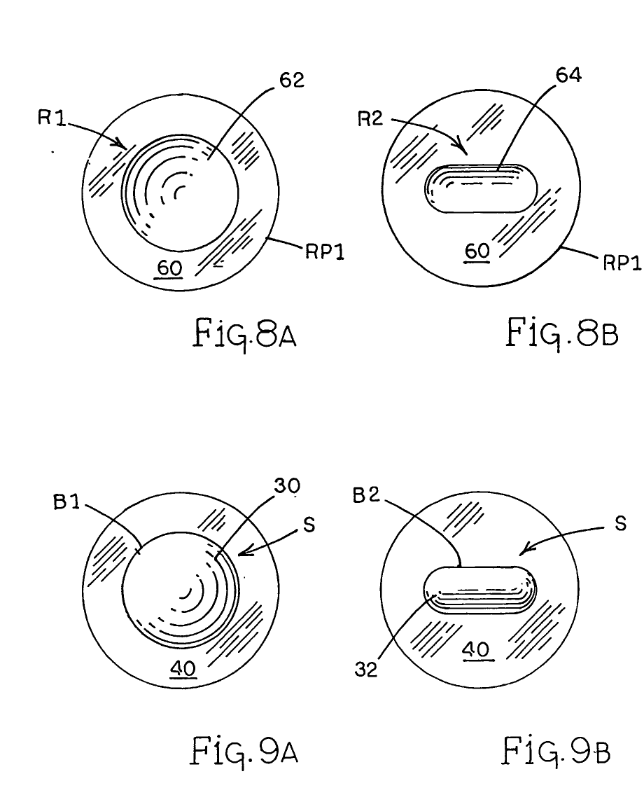

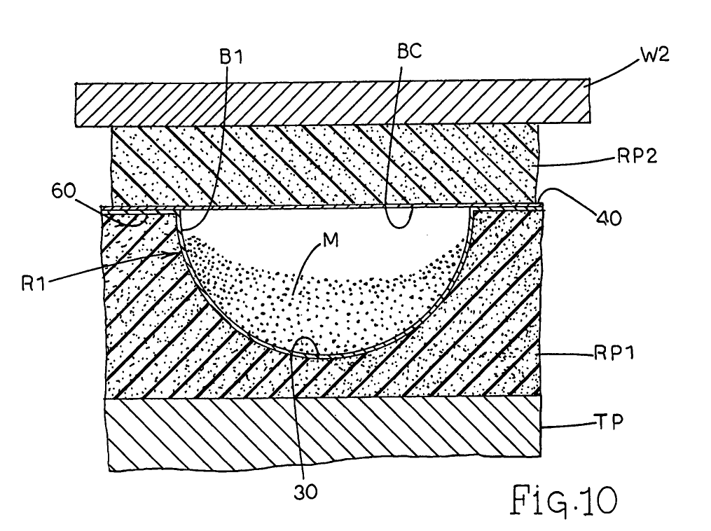

An additional embodiment of the present invention is illustrated in FIG. 6-10 of the drawings. In this embodiment, a resilient or elastomeric compound fixture or pad RP1 is attached to tip portion TP. As an alternative addition, a backing W2 can be provided and a resilient or elastomeric compound fixture or pad RP2 attached thereto. FIGS. 6, 7 and 8A illustrate one embodiment in which recess R1, defined in this embodiment by fixture or pad RP1, is circular shaped as seen on flat, top surface 60 of fixture or pad RP1, and recess R1 with its inner surface 62 is at least generally in the shape of a half of a sphere. FIG. 8B illustrates another embodiment in which recess R2 is oval-shaped as seen on flat, top surface 60 of fixture or pad RP1, and recess R2 with its inner surface 64 is at least generally in the shape of one half of an elongated tube. A backing W2, with or without a resilient fixture RP2 shown in FIGS. 6 and 10, may or may not be used in the invention depending on the particular application of the invention. FIGS. 9A and 9B show substrates S, in the form of blisters B1 and B2, which are compatible with recesses R1 and R2, respectively, wherein such recesses are defined by fixture or pad RP1.

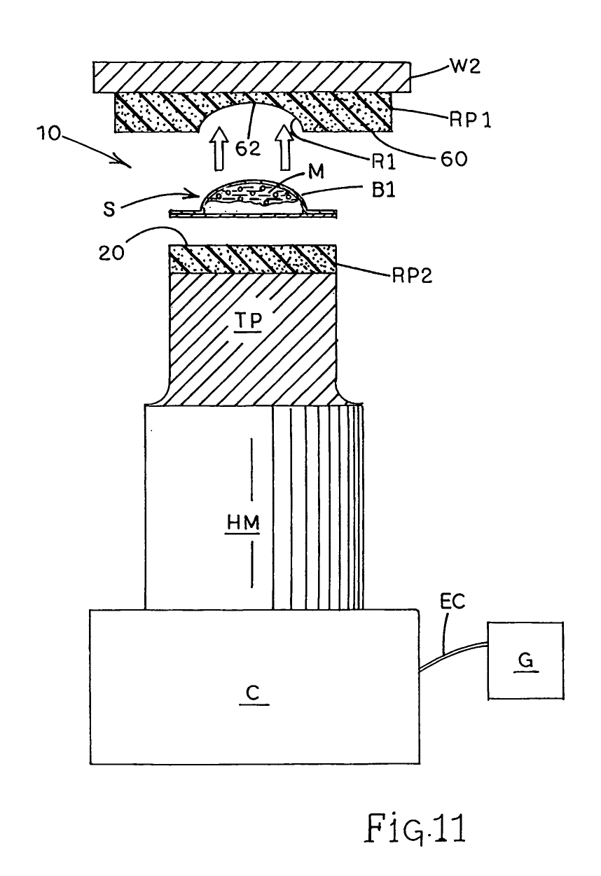

Referring to FIG. 11, another embodiment of the invention comprises an arrangement in which the orientation of fixtures or pads RP1 (and thus recess R1 and its inner surface 62) and RP2, as well as substrate S shown in the form of blister B1, are inverted as compared to the embodiments described hereinabove. Fixture or pad RP1 is thus attached to backing W2, and fixture or pad RP2 is attached to tip portion TP to present flat, top surface 20.

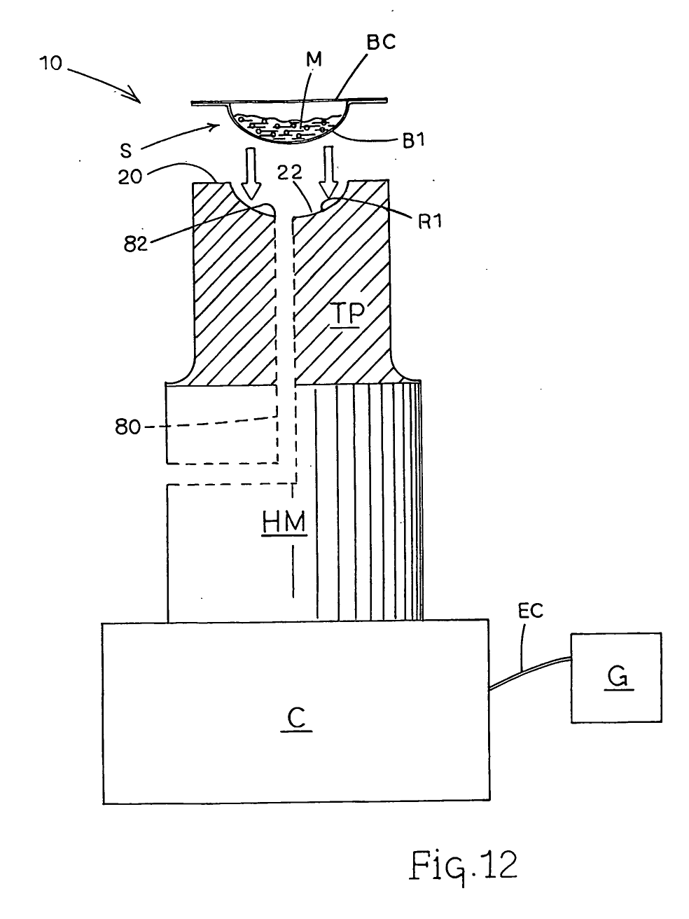

Referring to FIG. 12, a further embodiment of deagglomerator apparatus substitutes one or more vacuum lines 80 for backing W1 or W2 as a means for holding a blister such as blister B1 against tip portion TP and thereby assisting in the deagglomeration process. The location and origin of vacuum line 80 is not particularly critical, although any fittings required should not be detrimentally affected by the vibrational energy being transferred to tip portion TP. However, an orifice 82 of vacuum line 80 should be disposed such that a pressure differential is generated at a location sufficient to urge a blister or its substrate against tip portion TP or at least its associated recess. In FIG. 12, for example, vacuum orifice 82 is disposed in fluid communication with recess R1. As other possible alternatives not specifically shown, one or more vacuum orifices 82 could be disposed in fluid communication with top surface 20 of tip portion TP, or with resilient fixture RP1 shown in FIG. 11.

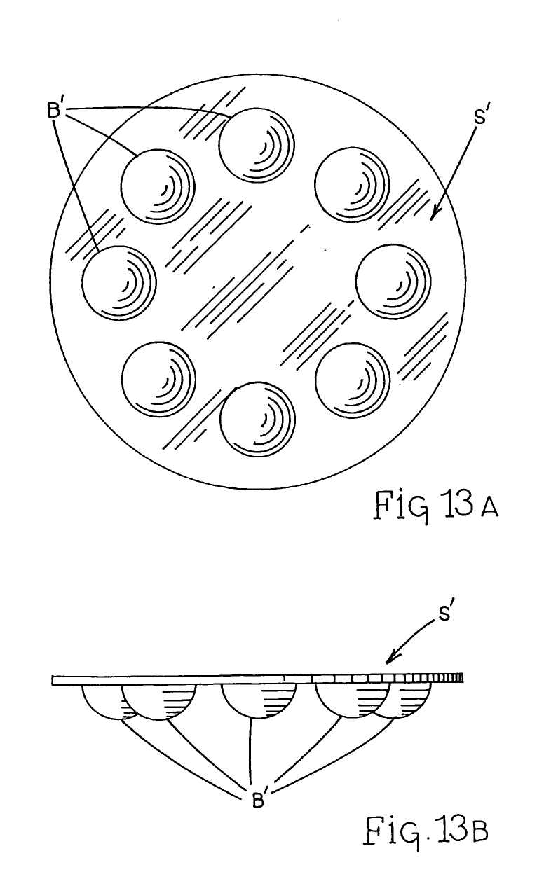

In another embodiment according to the present invention, deagglomerator apparatus 10 and particularly its tip portion TP are adapted to receive a plurality of blisters, such as a substrate S′ which includes an array of blisters B′ as shown in FIGS. 13A and 13B. It can then be seen that a multi-blister substrate such as substrate S′ enables vibrational transfer to, and thus deagglomeration at, a plurality of blisters simultaneously. A linear arrangement of multiple blisters is also contemplated. A plurality of blisters can be included on a single multi-blister substrate or on a plurality of individual substrates. It is thus also envisioned according to the present invention that deagglomerator apparatus 10 can incorporate a plurality of sonicating units—that is, a plurality of converters C, horn members HM, and tip portions TP as appropriate to the particular application.

In still another embodiment according to the present invention, resilient fixtures RP1 and/or RP2 can be provided in hollow form and filled with a suitable fluid, defined herein as a liquid or gel, in order to alter the characteristics of the vibrational energy transferred therethrough.

Moreover, in accordance with any of the embodiments described hereinabove, the present invention contemplates the application of multiple frequencies to drive a plurality of sonicating units, and either sequentially or simultaneously. For example, using a deagglomerator apparatus 10 having a single tip portion TP, vibrational energy of one frequency can be transferred to a substrate for a certain period of time, and vibrational energy of another frequency can be applied subsequently. For another example, using a deagglomerator apparatus 10 having multiple tip portions, vibrational energy of differing frequencies can be transferred through each tip portion to a substrate in order to superpose different frequencies on each other and thereby modify the deagglomerating effect. Moreover, deagglomerator apparatus 10 can be adapted to provide the user with the ability to adjust or vary the frequency during use, in order that an optimal frequency can be found which maximizes deagglomeration for a given substrate and/or a given medicament composition. In addition to varying the frequency, deagglomerator apparatus 10 can be adapted to provide the user with the ability to adjust or vary the amplitude or the power input in order to attain optimal resultant deagglomeration.

### Operation of Deagglomerator Apparatus and Method

For operation of the deagglomerator apparatus 10, a suitable substrate S is positioned within the recess of tip portion TP. For purposes of illustration and without limitation, FIG. 5 illustrates substrate S in the form of blister B1 received within recess R1 of tip portion TP. Material M is positioned and contained within blister B1, which includes a blister cover BC such that material M is entirely encapsulated and confined within blister B1.

Blister B1 is positioned within recess R1 preferably such that blister B1 at least substantially matingly engages recess R1. More specifically, blister B1 is preferably positioned within recess R1 such that the entire bottom surface of blister B1 is in continuous and flush contact or engagement with the inner surface of recess R1 with minimal or no space therebetween. A backing or weight W1 of any suitable type and configuration can be placed and rested upon flat, top surface 20 of blister B1 to ensure tight and intimate contact of the bottom surface of blister B1 with the inner surface of recess R1. It is envisioned according to this invention that backing or weight W1 can be constructed of a variety of components, and as can be appreciated by those of skill in the art, weight W1 can specifically comprise an elastomeric compound and can include or constitute an elastomeric layer of a suitable thickness, such as, for example, between approximately 0.0125 and 6 inches, as illustrated in FIG. 6 where backing W2 and associated elastomeric fixture or pad RP2 are provided. The applied pressure or weight of backing W1 likewise can be of any suitable magnitude, and backing W1 (or W2) can have a mass in the range, for example, between approximately 0 grams and 60 kilograms, and even more preferably between approximately 0 grams and 900 grams.

Electrical power from generator G provided to converter C as described above produces vibration which transfers through horn member HM and tip portion TP. As such, tip portion TP and recess R1 vibrate to cause blister B1 containing material M to also vibrate. In this fashion, the quantity of material M which was agglomerated when blister B1 was placed in recess R1 is at least partially deagglomerated so as to comprise micron-sized particles of an advantageously suitable size for inhalation and deposition into a person's lungs.

As can be appreciated by those of skill in the art, deagglomeration of material M in accordance with operation of deagglomerator apparatus 10 as described herein deagglomerates material M through a variety of mechanisms resulting from the vibration caused by converter C. Although it is envisioned in accordance with the present invention that other mechanisms can also have effect, three factors believed to actively contribute to deagglomeration include acoustic cavitation, acoustic streaming and mechanical force. Acoustic cavitation is produced in the media, which is air, due to pressure variations of the generated pressure waves. Acoustic streaming is the time-independent bulk motion of the media (air) generated through the loss of acoustic momentum by media (air) absorption or attenuation of the pressure waves. The mechanical force reflects momentum generated for the particles sufficient to overcome the particle-particle and particle-surface interactions.

As one of skill in the art will recognize, various control parameters are possible and exist for affecting the extent or amount of deagglomeration, such as the amount of power supplied, the frequency and amplitude utilized, the amount of operational time, substrate material S, blister cover material BC, the composition and mass of medicament M, the use and composition of (or absence of) resilient fixtures RP1 and/or RP2, the configuration of blister B and recess R1 with respect to horn member HM and tip portion TP, and the applied backing pressure if weight W1 is used.

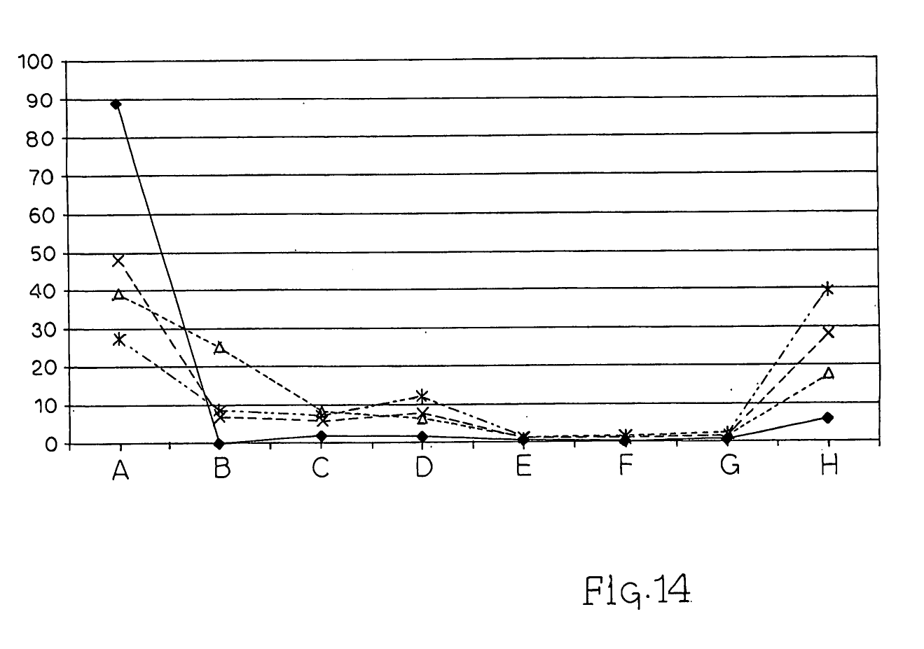

The graph set forth in FIG. 14 illustrates deagglomeration of material M in accordance with the present invention. Samples were prepared for the graph in FIG. 14 by dispensing an amount of a suspension made up of appropriate quantities of media and micron-sized material M into recess R2 and in substrate S such as those illustrated in FIGS. 8B and 9B, respectively. Following removal of the media, deagglomerator apparatus 10 and its associated method were applied to the samples prepared for the graph in FIG. 14 except for the control sample, to which deagglomerator apparatus 10 and its method were not applied. In order to evaluate the improvement in the deagglomeration state of the material in the samples to which deagglomerator apparatus 10 and its method were applied, over that of the control sample, the samples were analyzed by performing a cascade impaction assay in a manner known to those skilled in the art. Specifically, the cascade impaction assay was performed by presenting the samples to an Andersen Instruments Inc., MARK II™ cascade impactor device. The deagglomerated particles were introduced into the cascade impactor by passing a stream of gas over the substrate recess R2 in FIG. 8B, thus allowing the deagglomerated particles of material to be aerosolized and introduced into the cascade impactor. After introduction of the sample into the cascade impactor, the mass of material deposited on the various components were evaluated by high pressure liquid chromatography, the exact details of the assay and analysis being familiar to those knowledgeable in the art.

The x-axis of the graph is indicative of regional deposition along several points of the testing configuration. These testing points correlate to the illustrated data points A through H, which are identified according to the following legend:

| | |
|---|---|
| A | blister |
| B | lid |
| C | device |
| D | throat |
| E | inlet and stage 0 |
| F | stage 1 |
| G | stage 2 |
| H | filter |

The y-axis of the graph is indicative of the percent deposition at each testing point for each sample run, that is, for samples #1 through #4 with sample #1 being the control sample. The symbols representing the data points for each sample run and the corresponding test parameters are given by the following legend:

| Sample no. | plot | % weight | % time | % power |
|---|---|---|---|---|
| 1 | [symbol] | 0 | 0 | 0 |
| 2 | ---∈--- | 100 | 50 | 100 |
| 3 | —x— | 100 | 50 | 56 |
| 4 | — -(- — | 100 | 100 | 56 |

As can be appreciated by those skilled in the art, and as illustrated in the sample data shown in the graph in FIG. 14, optimal deagglomeration is a result of complex interactions of many factors and is best optimized for a particular set of conditions. The graph shows that as the power, time and applied pressure or weight of backing W1 are suitably adjusted, the medicament clearance from the blister increases from 11.0% for the undeagglomerated control blister to 72.6% for sample #4 to which deagglomerator apparatus 10 and method have been applied. At the same time, the fraction of micron-sized material M which was deagglomerated such that it comprised respirable particles or agglomerates of a median mass aerodynamic diameter of less than approximately six (6) microns (when referenced to unit density material of 1 gram/cm³) increased from 6.8% for the undeagglomerated control blister to 42.0% for sample #4 to which deagglomerator apparatus 10 and method have been applied.

Micron-sized material M is illustrated in FIGS. 1, 6 and 11 as at least partially agglomerated prior to application of the apparatus and method of the present invention, and is at least partially agglomerated at the time blister B1 is placed into recess R1. Micron-sized material M in FIGS. 5 and 10, however, is at least partially deagglomerated after application of the apparatus and method of the present invention. With reference to FIGS. 5 and 10, it should be noted that a thin layer of deagglomerated micron-sized material M may be present over the inside surfaces of blister B1, including the inside surface of blister cover BC.

After a suitable amount of material M has been deagglomerated, material M can be accessed at a suitable time for use of the now deagglomerated material in a variety of methods of use, as can be appreciated by those of skill in the art and as described in the background section above. For example, when the blister contains medicament powder, the deagglomerated medicament powder can be used for inhalation by suitable techniques into a person's lungs for deposition therein. Material M can be accessed in a variety of ways, such as by removing blister cover BC, or by inserting a needle or punching inlet and outlet holes through blister cover BC to introduce an air stream into blister B1.

It is further within the scope of the present invention to apply vibrational energy to a medicament-containing blister while evaporation is occurring, i.e., while suspending media still resides within the blister. This alternative takes advantage of the fact that vibrational energy can be transmitted more effectively through a liquid than through the air between the particles of the medicament. Vibrational energy transmitted in this manner can minimize particle contact and thus prevent agglomeration, thereby causing a fluidization effect and improving the deagglomerating functionality of the present invention.

The advantageous deagglomeration of micron-sized material M according to this invention can suitably deagglomerate material such that it comprises particles or agglomerates of a respirable size, which is preferably less than approximately ten (10) microns, more preferably less than approximately six (6) microns, and most preferably less than approximately five (5) microns (when referenced to unit density material of 1 gram/cm³), so that the particles can be inhaled into and deposited deeply into a person's lungs. Deagglomeration of micron-sized material M also facilitates efficiency in the use of material such as powder medicament in that the deagglomeration assists in and facilitates removal of micron-sized material M to avoid as much as possible any unnecessary wasting of micron-sized material M which might otherwise remain on the substrate.

It can therefore be seen that present invention provides a novel deagglomerator apparatus and method for deagglomerating material, particularly micron-sized powder medicament, suitable for inhalation and deposition into a person's lungs. It is also seen that the present invention provides such a deagglomerator apparatus and method for deagglomerating micron-sized material held by a substrate such as a blister. The deagglomerator apparatus of the present invention additionally can be understood to provide such a deagglomerator apparatus and method for deagglomerating micron-sized material which facilitates efficiency in using micron-sized material held by a substrate.

It will be understood that various details of the invention may be changed without departing from the scope of the invention. Furthermore, the foregoing description is for the purpose of illustration only, and not for the purpose of limitation, as the invention is defined by the following, appended claims.

What is claimed is:

1. A deagglomerator apparatus for deagglomerating a mass of at least partially agglomerated material such as a powder, the apparatus comprising:
(a) an elongate member suitable for transferring vibrational energy therethrough and having a tip portion, the tip portion defining a recess for holding material; and
(b) a vibrator mechanism attached to the elongate member, the vibrator mechanism being operable for vibrating the recess at a frequency and amplitude suitable for deagglomeration of the material held by the recess.

2. The deagglomerator apparatus of claim 1 comprising a vacuum line disposed in communication with the elongate member.

3. The deagglomerator apparatus of claim 1 wherein the tip portion defines a plurality of recesses, each recess adapted for holding the material.

4. The deagglomerator apparatus of claim 3 comprising a plurality of substrates, each substrate disposed in contact with a corresponding one of the plurality of recesses.

5. The deagglomerator apparatus of claim 1 comprising a plurality of tip portions, each tip portion defining at least one recess for holding the material.

6. The deagglomerator apparatus of claim 5 comprising a plurality of vibrator mechanisms, each vibrator mechanism adapted to transfer vibrational energy to a corresponding one of the plurality of tip portions.

7. The deagglomerator apparatus of claim 1 comprising a distal portion attached to the tip portion and defining the recess, the distal portion constructed from a material different from the tip portion.

8. The deagglomerator apparatus of claim 7 wherein the distal portion is constructed from a ceramic material.

9. The deagglomerator apparatus of claim 1 comprising a resilient element contacting the tip portion and defining the recess.

10. The deagglomerator apparatus of claim 9 wherein the resilient element is contructed from an elastomeric material.

11. The deagglomerator apparatus of claim 9 wherein the resilient element is hollow and filled with a fluid.

12. The deagglomerator apparatus of claim 9 wherein the recess opens away from the tip portion.

13. The deagglomerator apparatus of claim 1 wherein the recess defined by the tip portion has a length ranging from approximately 0.2 to approximately 0.5 inch, a width ranging from approximately 0.1 to approximately 0.4 inch, and a depth ranging from approximately 0.05 to 0.2 inch in depth.

14. The deagglomerator apparatus of claim 13 wherein the recess has a length of approximately 0.26 inch, a width of approximately 0.15 inch, and a depth of approximately 0.07 inch.

15. The deagglomerator apparatus of claim 13 wherein the recess has a length of approximately 0.236 inch, a width of approximately 0.153 inch, and a depth of approximately 0.061 inch.

16. The deagglomerator apparatus of claim 1 wherein the recess has a diameter of approximately 0.5 inch and a depth of approximately 0.16 inch.

17. The deagglomerator apparatus of claim 1 comprising a resilient element defining the recess, wherein the recess opens toward the tip portion.

18. The deagglomerator apparatus of claim 17 comprising a backing weight, wherein the resilient element defining the recess is attached to the backing weight.

19. The deagglomerator apparatus of claim 1 comprising a substrate for holding the material, wherein at least a portion of the substrate is receivable within the recess.

20. The deagglomerator apparatus of claim 19 comprising a resilient element attached to the tip portion and defining the recess.

21. The deagglomerator apparatus of claim 19 comprising a backing weight adapted to urge the substrate against the recess.

22. The deagglomerator apparatus of claim 21 comprising a resilient pad attached to the backing weight and adapted to contact the substrate.

23. The deagglomerator apparatus of claim 19 wherein the substrate includes a blister.

24. The deagglomerator apparatus of claim 19 wherein the substrate includes a screen having a plurality of interstices adapted for holding micron-sized material.

25. The deagglomerator apparatus of claim 19 wherein the substrate includes a ball.

26. The deagglomerator apparatus of claim 19 comprising a vacuum line disposed in operative communication with a vacuum supply source and adapted for fluid communication with the substrate.

27. The deagglomerator apparatus of claim 1 wherein the recess is substantially circular in shape on a top surface of the tip portion.

28. The deagglomerator apparatus of claim 1 wherein the recess is substantially oval in shape on a top surface of the tip portion.

29. The deagglomerator apparatus of claim 1 wherein the vibrator mechanism is an ultrasonic converter for providing vibration at a frequency of approximately 20 kHz or higher.

30. The deagglomerator apparatus of claim 1 wherein the vibrator mechanism is a sonic converter for providing vibration at a frequency of less than approximately 20 kHz.

31. The deagglomerator apparatus of claim 1 wherein the vibrator mechanism transfers vibrational energy at a frequency ranging between approximately 60 Hz to approximately 1000 kHz.

32. The deagglomerator apparatus of claim 31 wherein the vibrator mechanism transfers vibrational energy at a frequency ranging between approximately 10 kHz to approximately 120 kHz.

33. The deagglomerator apparatus of claim 1 wherein the vibrator mechanism is adapted to transfer vibrational energy at an adjustable frequency.

34. The deagglomerator apparatus of claim 1 wherein the vibrator mechanism is adapted to cause the tip portion to vibrate at an amplitude ranging between approximately 1000 to approximately 0 micrometers.

35. The deagglomerator apparatus of claim 1 wherein the vibrator mechanism is adapted to cause the tip portion to vibrate at an amplitude ranging between approximately 120 to approximately 0 micrometers.

36. The deagglomerator apparatus of claim 34 wherein the vibrator mechanism is adapted to cause the tip portion to vibrate at an amplitude ranging between approximately 60 to approximately 0 micrometers.

37. The deagglomerator apparatus of claim 1 wherein the vibrator mechanism is adapted to transfer vibrational energy at an adjustable amplitude.

38. A deagglomerator apparatus for deagglomerating a mass of at least partially agglomerated material comprising:
(a) a substrate for holding material;
(b) a horn member having a tip portion, the tip portion defining a recess for receiving at least a portion of the substrate; and
(c) a vibrator mechanism attached to the horn member, the vibrator mechanism being operable for vibrating both the recess and the substrate at a frequency and amplitude suitable for at least partial deagglomeration of agglomerated material held by the portion of the substrate while the portion of the substrate is received in the recess.

39. The deagglomerator apparatus of claim 38 wherein the substrate comprises a blister for holding the material.

40. The deagglomerator apparatus of claim 39 wherein the blister is adapted for holding approximately 5000 micrograms or less of the material therein.

41. The deagglomerator apparatus of claim 39 wherein the blister includes a cover for encapsulating the material within the blister.

42. The deagglomerator apparatus of claim 38 wherein the recess defined by the tip portion has a planar surface area of approximately 0.2 square inches or less.

43. The deagglomerator apparatus of claim 38 wherein the recess is substantially circular in shape on a top surface of the tip portion.

44. The deagglomerator apparatus of claim 38 wherein the recess is substantially oval in shape on a top surface of the tip portion.

45. The deagglomerator apparatus of claim 38 wherein the recess includes an upper surface adapted for substantially matingly engaging a bottom surface of at least the portion of the substrate.

46. A method for deagglomerating agglomerated micron-sized material suitable for inhalation into a person's lungs, the method comprising the steps of:
(a) placing agglomerated material in a recess defined by a structural member; and
(b) vibrating the structural member to vibrate the recess and the agglomerated material placed within the recess at a frequency and amplitude such that at least a portion of the agglomerated material within the recess is deagglomerated.

47. The method of claim 46 further comprising an initial step of forming the agglomerated material from a suspension.

48. The method of claim 47 comprising the step of allowing the suspension to dry in order to provide an agglomerated medicament powder.

49. The method of claim 47 wherein the recess and agglomerated material is vibrated prior to complete evaporation of the suspension.

50. The method of claim 46 further comprising the step of covering the material within the recess.

51. The method of claim 46 wherein the recess and agglomerated material within the recess are vibrated at a frequency of approximately 20 kHz or higher.

52. The method of claim 46 wherein the recess and agglomerated material are vibrated at a frequency of less than approximately 20 kHz.

53. The method of claim 46 wherein the recess and agglomerated material are vibrated at a plurality of different frequencies.

54. The method of claim 46 wherein the recess and agglomerated material are vibrated at an amplitude of approximately 60 micrometers or greater.

55. The method of claim 46 wherein the recess and agglomerated material are vibrated at an amplitude of approximately 60 micrometers or less.

56. The method of claim 46 comprising the steps of providing a substrate to hold the agglomerated material and placing at least a portion of the substrate in the recess defined by a structural member.
